(19) United States
(12) Patent Application Publication
(10) Pub. No.: US 2006/0161896 A1
(43) Pub. Date: Jul. 20, 2006

(54) Performing debug requests that are within the debug domain of a class loader

(75) Inventors: Daniel Rodman Hicks, Byron, MN (US); Mark Douglas Schroeder, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 11/035,551

(22) Filed: Jan. 14, 2005

(51) Int. Cl. G06F 9/44

(52) U.S. Cl. 717/124

(57) ABSTRACT

A method, apparatus, system, and signal-bearing medium that, in an embodiment, receive a request to load a class and decide whether debug is enabled for the class. If debug is enabled, a class loader with debug enabled is created. The class and all classes subsequently loaded by the debug-enabled class loader are then kept in interpreted mode. In response to a debug request directed to the class, a determination is made whether a class loader with debug enabled loaded the class. If the class loader with debug enabled did load the class, the debug request is performed; otherwise, the debug request is rejected.

### FIELD

This invention generally relates to computer systems and more specifically relates to performing a debug request directed to class if the class is within the debug domain of a class loader.

### BACKGROUND

The development of the EDVAC computer system of 1948 is often cited as the beginning of the computer era. Since that time, computer systems have evolved into extremely sophisticated devices that may be found in many different settings. Computer systems typically include a combination of hardware (e.g., semiconductors, circuit boards, etc.) and software (e.g., computer programs). As advances in semiconductor processing and computer architecture push the performance of the computer hardware higher, more sophisticated computer software has evolved to take advantage of the higher performance of the hardware, resulting in computer systems today that are much more powerful than just a few years ago.

As the sophistication and complexity of computer software increase, the more difficult the software is to debug. Bugs are problems, faults, or errors in a computer program. Locating, analyzing, and correcting suspected faults in a computer program is a process known as “debugging.” Typically, a programmer uses another computer program commonly known as a “debugger” to debug a program or application under development.

Conventional debuggers typically support two primary operations to assist a computer programmer. A first operation supported by conventional debuggers is a “step” function, which permits a computer programmer to process instructions (also known as “statements”) in a computer program one-by-one and see the results upon completion of each instruction. While the step operation provides a programmer with a large amount of information about a program during its execution, stepping through hundreds or thousands of program instructions can be extremely tedious and time consuming and may require a programmer to step through many program instructions that are known to be error-free before a set of instructions to be analyzed are executed.

To address this difficulty, a second operation supported by conventional debuggers is a breakpoint operation, which permits a computer programmer to identify with a breakpoint a precise instruction for which it is desired to halt execution of a computer program. As a result, when a computer program is executed by a debugger, the program executes in a normal fashion until a breakpoint is reached. The debugger then stops execution of the program and displays the results of the program to the programmer for analysis.

Typically, step operations and breakpoints are used together to simplify the debugging process. Specifically, a common debugging operation is to set a breakpoint at the beginning of a desired set of instructions to be analyzed and then begin executing the program. Once the breakpoint is reached, the debugger halts the program, and the programmer then steps through the desired set of instructions line-by-line using the step operation. Consequently, a programmer is able to more quickly isolate and analyze a particular set of instructions without needing to step through irrelevant portions of a computer program. Although step operations and breakpoints are the two fundamental functions support by virtually all debuggers, many other function are also possible.

Human programmers often write the computer programs that need to be debugged in a form of computer language that is relatively easy for a human to understand, but which is not efficient for the computer to execute. Another program, such as a compiler or interpreter, then transforms the program into a form that is more efficient for the computer to execute, but relatively difficult for a human to understand. One example of an interpreter is the Java Virtual Machine (JVM), which is a software layer that interprets and executes Java byte codes.

One of the major issues in using the Java programming language, or any interpreted language, is performance. Unfortunately, a standard Java Virtual Machine does not typically yield high-performing programs. In order to increase performance, a technique called just-in-time (JIT) compilation is sometimes used to execute Java code inside the Java Virtual Machine. Through just-in-time compilation, a Java byte code method is dynamically translated into a native method (code native to the computer on which the program is executing) as the method executes, so as to remove the interpretation overhead of a typical Java Virtual Machine implementation.

Current debugging technology requires that the Java applications be started in a special debug mode, which informs the JVM at startup that the user may want to do some type of debugging with the application. When in this debug mode, the JVM selectively disables certain performance optimizations that are incompatible with debugging features for all classes of the application. For example the debug mode causes the JVM to either limit the optimizations performed by the just-in-time (JIT) compiler or completely disable the JIT compiler, which forces all methods of the application to be run using an interpreter, which is slower than executing native code generated by the JIT compiler.

Large applications such as application servers are difficult to debug because of the aforementioned problems; running an entire application server with an interpreter will often cause unacceptable performance degradation. Furthermore, the user is required to bring down the application server and re-start it, specifying the appropriate debug options, which is inconvenient for other users. Finally, allowing a user to debug an entire application gives the user extensive access to the application, including parts unrelated to the component being debugged, which could cause potential security exposures and risk of bringing down the entire application.

Thus, without a better way to debug applications, especially large applications, users will continue to experience performance problems, inconvenience, and security exposures. Although the aforementioned problems have been described in the context of Java, they may occur in the context of any interpreted computer language.

### SUMMARY

A method, apparatus, system, and signal-bearing medium are provided that, in an embodiment, receive a request to load a class and decide whether debug is enabled for the class. If debug is enabled, a class loader with debug enabled is created. The class and all classes subsequently loaded by the debug-enabled class loader are then kept in interpreted mode. In response to a debug request directed to the class, a determination is made whether a class loader with debug enabled loaded the class. If the class loader with debug enabled did load the class, the debug request is performed; otherwise, the debug request is rejected.

### BRIEF DESCRIPTION OF THE DRAWINGS

Various embodiments of the present invention are hereinafter described in conjunction with the appended drawings:

FIG. 1 depicts a high-level block diagram of an example system for implementing an embodiment of the invention.

FIG. 2 depicts a block diagram of selected components of the example system, according to an embodiment of the invention.

FIG. 3 depicts a flowchart of example processing for interpreting an application, according to an embodiment of the invention.

FIG. 4 depicts a flowchart of example processing for creating an internal representation of a class, according to an embodiment of the invention.

FIG. 5 depicts a flowchart of example processing for debugging an application, according to an embodiment of the invention.

FIG. 6 depicts a flowchart of example processing for processing debug requests from an agent, according to an embodiment of the invention.

It is to be noted, however, that the appended drawings illustrate only example embodiments of the invention, and are therefore not considered limiting of its scope, for the invention may admit to other equally effective embodiments.

### DETAILED DESCRIPTION

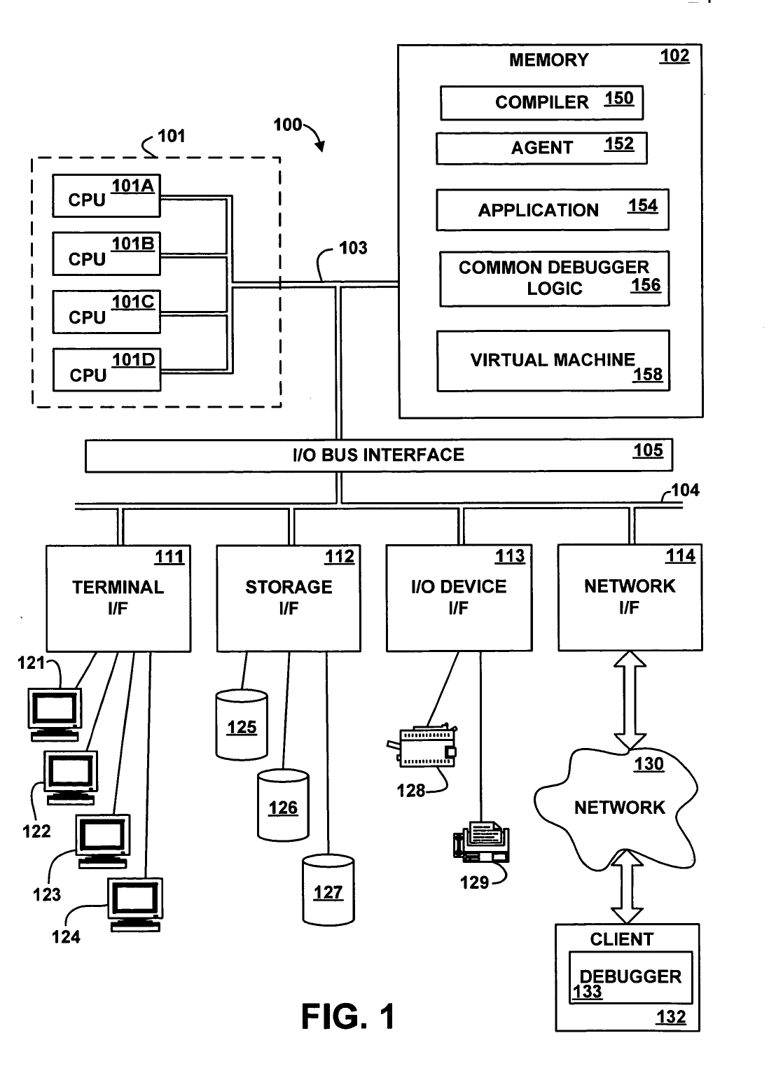

Referring to the Drawings, wherein like numbers denote like parts throughout the several views, FIG. 1 depicts a high-level block diagram representation of a computer system 100 connected via a network 130 to a client 132, according to an embodiment of the present invention. In an embodiment, the hardware components of the computer system 100 may be implemented by an IBM eServer iSeries computer system. However, those skilled in the art will appreciate that the mechanisms and apparatus of embodiments of the present invention apply equally to any appropriate computing system.

The major components of the computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as the processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

The main memory 102 is a random-access semiconductor memory for storing data and programs. In another embodiment, the main memory 102 represents the entire virtual memory of the computer system 100, and may also include the virtual memory of other computer systems coupled to the computer system 100 or connected via the network 130. The main memory 102 is conceptually a single monolithic entity, but in other embodiments the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

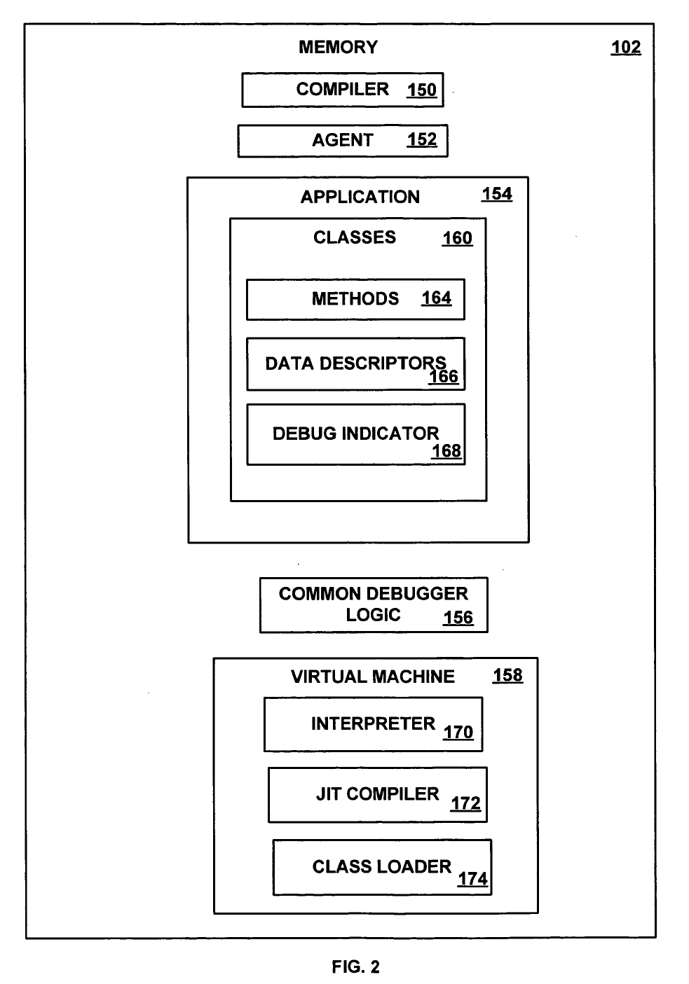

The memory 102 includes a compiler 150, an agent 152, an application 154, common debugger logic 156, and a virtual machine 158, all of which are further- described below in more detail with reference to FIG. 2. Although the compiler 150, the agent 152, the application 154, the common debugger logic 156, and the virtual machine 158 are illustrated as being contained within the memory 102 in the computer system 100, in other embodiments some or all of them may be on different computer systems and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, the compiler 150, the agent 152, the application 154, the common debugger logic 156, and the virtual machine 158 are not necessarily all completely contained in the same storage device at the same time.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI bus, or any other appropriate bus technology.

The I/O interface units support communication with a variety of storage and I/O devices. For example, the terminal interface unit 111 supports the attachment of one or more user terminals 121, 122, 123, and 124. The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the main memory 102 may be stored to and retrieved from the direct access storage devices 125, 126, and 127.

The I/O and other device interface 113 provides an interface to any of various other input/output devices or devices of other types. Two such devices, the printer 128 and the fax machine 129, are shown in the exemplary embodiment of FIG. 1, but in other embodiment many other such devices may exist, which may be of differing types. The network interface 114 provides one or more communications paths from the computer system 100 to other digital devices and computer systems; such paths may include, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

The computer system 100 depicted in FIG. 1 has multiple attached terminals 121, 122, 123, and 124, such as might be typical of a multi-user “mainframe” computer system. Typically, in such a case the actual number of attached devices is greater than those shown in FIG. 1, although the present invention is not limited to systems of any particular size. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100. In various embodiments, the network 130 may represent a storage device or a combination of storage devices, either connected directly or indirectly to the computer system 100. In an embodiment, the network 130 may support Infiniband. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3x specification. In another embodiment, the network 130 may be the Internet and may support IP (Internet Protocol).

In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number (including zero) of networks (of the same or different types) may be present.

The client 132 includes a debugger 133. The client 132 may further include any or all of the elements previously described above for the computer system 100. A user at the client 132 interacts with the debugger 133 in order to send requests to the agent 152, which further sends requests to the common debugger logic 156, for the purpose of debugging the application 154. In another embodiment, the debugger 133 may be present in the memory 102 of the computer system 100, and the client 132 is optional, not present, or not used.

It should be understood that FIG. 1 is intended to depict the representative major components of the computer system 100, the network 130, and the client 132 at a high level, that individual components may have greater complexity than represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer system 100, and that, when read and executed by one or more processors 101 in the computer system 100, cause the computer system 100 to perform the steps necessary to execute steps or elements comprising the various aspects of an embodiment of the invention.

Moreover, while embodiments of the invention have and hereinafter will be described in the context of fully-functioning computer systems, the various embodiments of the invention are capable of being distributed as a program product in a variety of forms, and the invention applies equally regardless of the particular type of signal- bearing medium used to actually carry out the distribution. The programs defining the functions of this embodiment may be delivered to the computer system 100 via a variety of signal-bearing media, which include, but are not limited to:

(1) information permanently stored on a non-rewriteable storage medium, e.g., a read-only memory device attached to or within a computer system, such as a CD-ROM, DVD−R, or DVD+R;

(2) alterable information stored on a rewriteable storage medium, e.g., a hard disk drive (e.g., the DASD 125, 126, or 127), CD−RW, DVD−RW, DVD+RW, DVD−RAM, or diskette; or

(3) information conveyed by a communications medium, such as through a computer or a telephone network, e.g., the network 130, including wireless communications.

Such signal-bearing media, when carrying machine-readable instructions that direct the functions of the present invention, represent embodiments of the present invention.

Embodiments of the present invention may also be delivered as part of a service engagement with a client corporation, nonprofit organization, government entity, internal organizational structure, or the like. Aspects of these embodiments may include configuring a computer system to perform, and deploying software systems and web services that implement, some or all of the methods described herein. Aspects of these embodiments may also include analyzing the client company, creating recommendations responsive to the analysis, generating software to implement portions of the recommendations, integrating the software into existing processes and infrastructure, metering use of the methods and systems described herein, allocating expenses to users, and billing users for their use of these methods and systems.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

FIG. 2 depicts a block diagram of selected components in memory 102 of the example system, according to an embodiment of the invention. The memory 102 includes the compiler 150, the agent 152, the application 154, the common debugger logic 156, and the virtual machine 158, all of which may in various embodiments have any number of instances.

The compiler 150 compiles the application 154 into byte codes, which the virtual machine 158 uses as input. In an embodiment, the compiler 150 may be implemented by the javac compiler, but in other embodiments any appropriate compiler that generates instructions that are understood by the virtual machine 158 may be used. In an embodiment, the compiler 150 is a static compiler and does not generate instructions that execute directly on the processor 101.

The agent 152 is a representative of a started debug session and is associated with a particular user's client debugger 133 (FIG. 1) on one side and a set of debug control information maintained by the virtual machine 158 on the other side. The debug control information includes the identity of the class loader or loaders to which the agent 152 (and hence user) is authorized and/or some means for determining these loaders by, e.g., comparing the user's user ID (identifier) to a user ID specified when a class loader was created for debug.

The application 154 includes any number of classes 160, which include methods 164, data descriptors 166, and a debug indicator 168. The application 154 may be any source code, whether written by a user, a third party developer, the designer of the computer system 100, or of any other origin. The method 164 is a unit within the application 154 that may be invoked, called, or sent requests. The debug indicator 168 indicates whether a particular class is within a debug domain and is maintained on a per-class basis.

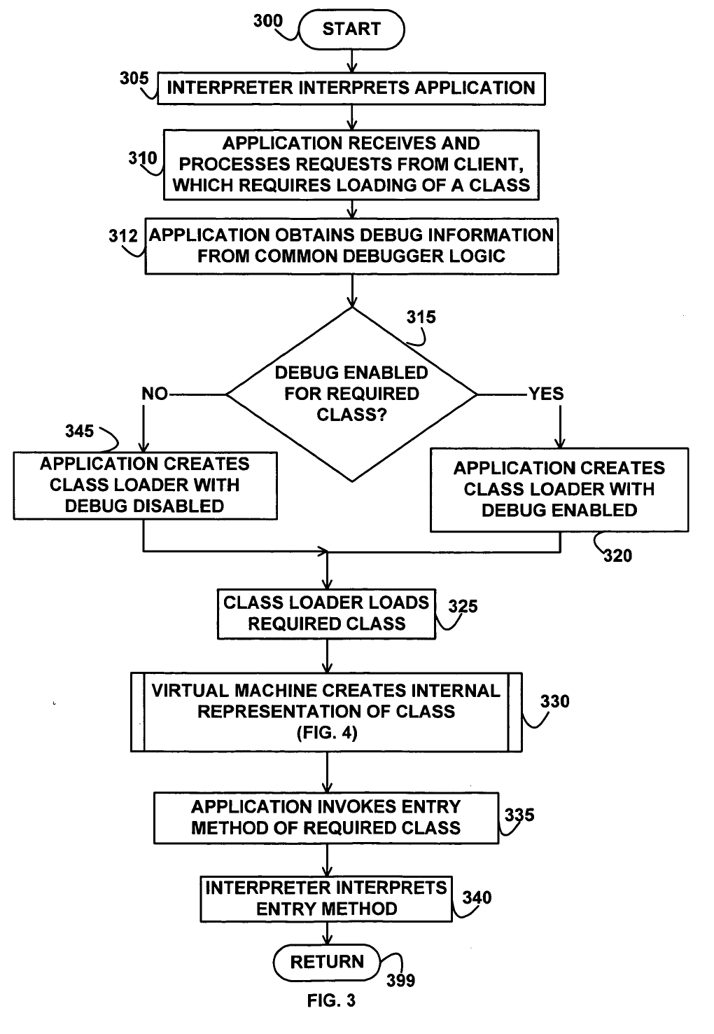

The common debugger logic 156 receives debug requests from the agent 152 and processes them with respect to the application 154. In an embodiment, the agent 152 and the common debugger logic 156 include instructions capable of executing on the processor 101 or statements capable of being interpreted by instructions executing on the processor 101 to perform the functions as further described below with reference to FIGS. 3, 4, 5, and 6. In another embodiment, the agent 152 and the common debugger logic 156 may be implemented in microcode. In another embodiment, the agent 152 and the common debugger logic 156 may be implemented in hardware via logic gates and/or other appropriate hardware techniques.

The virtual machine 158 includes an interpreter 170, a just-in-time compiler 172, and a class loader 174. The interpreter 170 interprets the byte code form of the method 164. The just-in-time compiler 172 is invoked by the interpreter 170 when necessary to compile the byte code form of the method 164. In contrast to the compiler 150, the just-in-time compiler 172 is a dynamic compiler instead of a static compiler; further, the just-in-time compiler 172 generates instructions that execute directly on the processor 101.

The virtual machine 158 employs the class loader 174 to load the classes 160 used by the application 154. Although the classes 160 are illustrated as being contained within the application 154, in other embodiments, the class loader 174 may use a classpath, which informs the class loader 174 where to find third-party and user-defined classes. Classpath entries may be directories that contain classes not in a package, the package root directory for classes in a package, or archive files (e.g. zip or jar files) that contain classes. The class loader 174 loads classes in the order they appear in the classpath. For example, starting with the first classpath entry, the class loader 174 visits each specified directory or archive file attempting to find the class to load. The first class found with the proper name is loaded, and any remaining classpath entries are ignored.

In an embodiment, the class loader 174 loads the classes 160 only when needed, which is sometimes called lazy or on-demand loading. But, in another embodiment, the class loader 174 loads at least a subset of the classes 160 on startup of the application 154. Each class that is loaded by the class loader 174 may have other classes that it depends on, so the loading process may be recursive. When a class is loaded and initialized, the virtual machine 158 decodes the binary class format, checks compatibility with other classes, verifies the sequence of byte code operations, and constructs a class instance to represent the new class. This class object becomes the basis for all instances of the new class created by the virtual machine 158. The class object is also the identifier for the loaded class itself; multiple copies of the same binary class can be loaded in the virtual machine 158, each with its own class instance. Even though these copies all share the same class name, they will be separate classes to the virtual machine 158.

The class loader 174 is responsible for searching for a particular class in the classes 160 and making that class available to the virtual machine 158 if found. Once loaded, each class object retains a reference to the class loader 174 with which it was loaded. In an embodiment, class loading is based on a parent-first class loading delegation model, wherein a class loader 174 first delegates the class loading responsibility to its immediate parent class loader 174. If neither that parent class loader 174 nor any of its ancestors, in turn, are able to locate the class, then the initial class loader 174 is used for the loading operation. Inheritance in the class loader 174 chain is under control of the programmer, who may specify an explicit parent relationship when creating a new class loader 174. In another embodiment, a parent-last or any other appropriate class loading model may be used. Each time a class loader 174 is created, it is associated with one or more locations (such as file tree structures and archives) that it will be searching for classes. Thus, multiple class loaders 174 may exist, and each may have its own class path, or in another embodiment only one class path may be used for all of the class loaders 174.

FIG. 3 depicts a flowchart of example processing for interpreting the application 154, according to an embodiment of the invention. Control begins at block 300. Control then continues to block 305 where the interpreter 170 begins interpreting the application 154. Control then continues to block 310 where the application 154 receives and processes requests from the client 132, where at least one of the requests requires loading of one of the classes 160.

Control then continues to block 312 where the application 154 obtains debug information from the common debugger logic 156. The common debugger logic 156 receives debugging information from the agent 152 regarding what classes and/or class loaders need to be enabled. In an embodiment, the agent 152 sends the debug information to the common debugger logic 156 in response to debug information received from the client 132. The client 132 may provide debug information to the agent 152 in the form of a command option used when starting the application 154 or by performing an action in the debugger 133, such as setting a breakpoint in a method 164. Thus, in an embodiment, the common debugger logic 156 determines how the class loader 174 should be created based on the previously-received debugging information from the agent 152, and the common debugger logic 156 supplies this information to the application 154. In another embodiment, the common debugger logic 156 has access to a pre-existing database, such as a table of the classes 160 and the request types that correspond to them, so that the agent 152 need not send the classes 160 or the class loader 174 to the common debugger logic 156. Instead, the agent 152 merely identifies the request type, and the common debugger logic 156 subsequently identifies the associated classes 160 and their class loader 174 via the database.

Control then continues to block 315 where a determination is made whether the debug indicator 168 for the required class is enabled. If the determination at block 315 is true, then debug is enabled for the required class, so control continues to block 320 where the application 154 creates the class loader 174 for the required class with debug enabled, i.e., the application 154 creates a debug domain by creating a class loader 174 that allows debugging. In an embodiment, the application 154 creates a new class loader 174 for each request from the client 132 or other unit of work, e.g., a request for a page or other data. Thus, the class loader 174 is created for the root class in the unit of work, and by the usual rules of class loaders, the references from the root class also end up being processed by the same class loader 174.

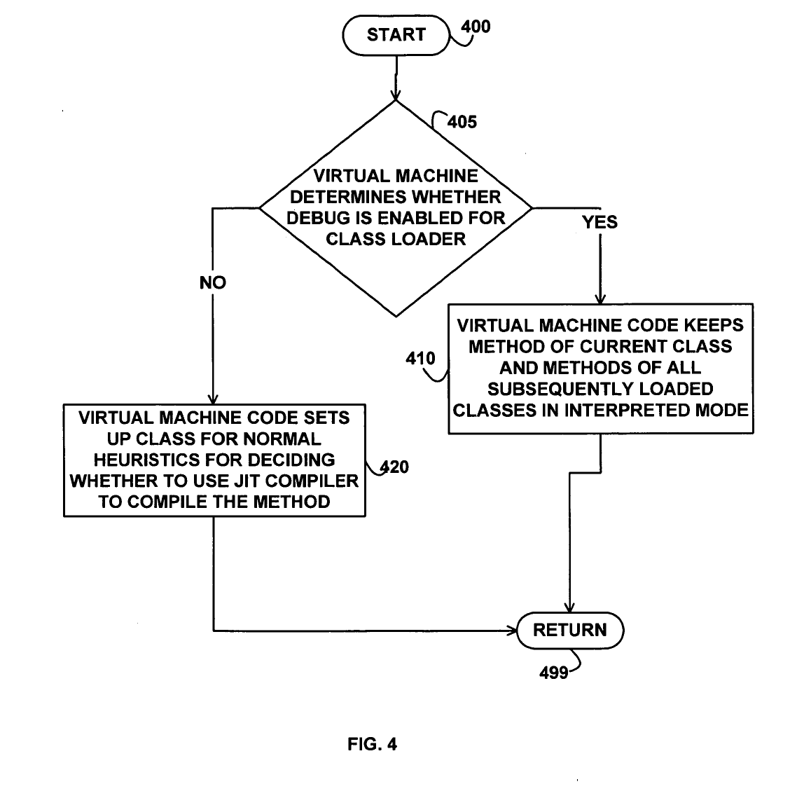

Control then continues to block 325 where the created class loader 174 loads the required class. Control then continues to block 330 where the virtual machine 158 creates an internal representation of the class, as further described below with reference to FIG. 4. Control then continues to block 335 where the application 154 invokes the entry method (one of the methods 164) of the loaded class. Control then continues to block 340 where the interpreter 170 interprets the entry method. Control then continues to block 399 where the logic of FIG. 3 returns.

If the determination at block 315 is false, then debug is not enabled for the required class, so control continues to block 345 where the application 154 creates the class loader 174 with debug disabled, i.e., the application 154 creates a non-debug domain by creating a class loader 174 that does not allow debugging. Control then continues to block 325, as previously described above.

FIG. 4 depicts a flowchart of example processing for creating an internal representation of a class, according to an embodiment of the invention. Control begins at block 400. Control then continues to block 405 where the virtual machine 158 determines whether debug is enabled for the class loader 174, which was previously created at block 320 or 345 of FIG. 3. The virtual machine 154 makes this determination by inspecting the debug indicator flag 168 in the class loader 174, which is itself a class 160. In another embodiment, the class loader 174 is not a class 160; instead, the debug indicator 168 is kept as part of the internal data of the virtual machine 158. Thus, a separate debug indicator 168 in every class 160 is not necessary since every class 160 has a class loader 174, and the virtual machine 158 refers to the debug indicator 168 of the class loader 174 to find the debug indicator 168 of any class 160.

If the determination at block 405 is true, then debug is enabled for the class loader 174, so control continues to block 410 where the virtual machine 158 keeps the method 164 of the current class 160 and methods 164 of all subsequently loaded classes in interpreted mode, such that the interpreter 170 interprets the methods 164 instead of using the JIT compiler 172. The virtual machine 158 further sets the debug indicator 168 for the class being loaded to the same state (in this case debug enabled) as the debug indicator flag 168 for its class loader 174. Control then continues to block 499 where the logic of FIG. 4 returns. If the determination at block 405 is false, then debug is not enabled for the class loader 174, so control continues to block 420 where the virtual machine 158 sets up the class 160 for normal heuristics for deciding by the interpreter 170 whether to use the JIT compiler 172 to compile the method 164. The virtual machine 158 further sets the debug indicator 168 for the class being loaded to the same state (in this case debug disabled) as the debug indicator flag 168 for its class loader 174. Control then continues to block 499 where the logic of FIG. 4 returns.

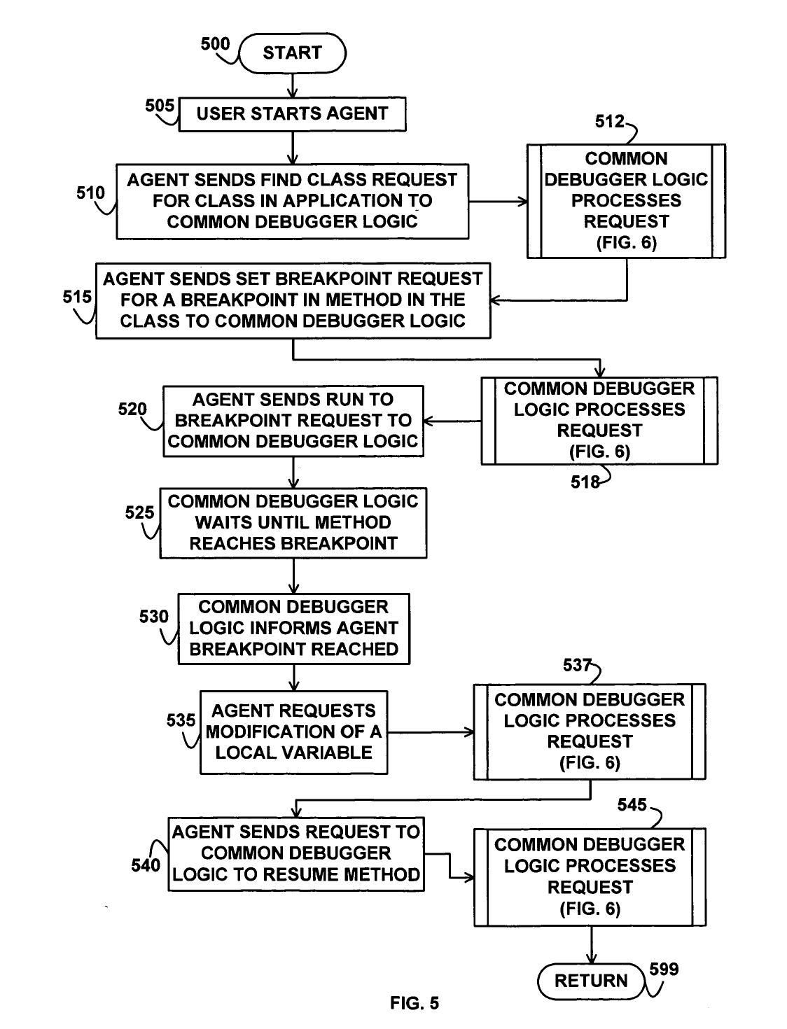

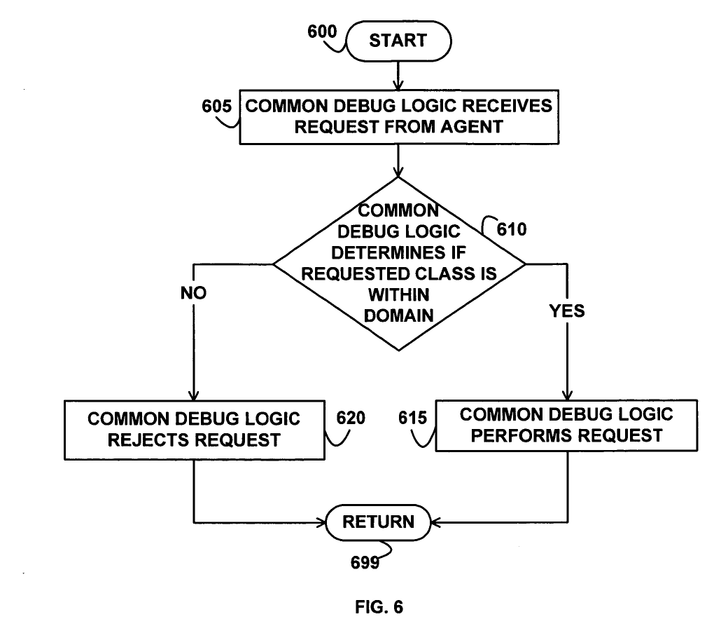

FIG. 5 depicts a flowchart of example processing for debugging the application 154, according to an embodiment of the invention. Control begins at block 500. Control then continues to block 505 where the user starts the agent 152. Control then continues to block 510 where the agent 152 sends a find class request for a class in the classes 160 of the application 154 to the common debugger logic 156. Control then continues to block 512 where the common debugger logic 156 processes the request, as further described below with reference to FIG. 6.

Control then continues to block 515 where the agent 152 sends a set breakpoint request for a breakpoint in a method 164 in the class 160 of the application 154 to the common debugger logic 156. Control then continues to block 518 where the common debugger logic 156 processes the request, as further described below with reference to FIG. 6.

Control then continues to block 520 where the agent 152 sends a run to breakpoint request for a breakpoint in a method 164 in the class 160 of the application 154 to the common debugger logic 156. Control then continues to block 525 where the common debugger logic 156 processes the request by waiting until the method 164 reaches the breakpoint.

Control then continues to block 530 where the common debugger logic 156 informs the agent 152 that the breakpoint has been reached. Control then continues to block 535 where the agent 152 sends a request for a modification of a local variable of the method 164 in the class 160 of the application 154 to the common debugger logic 156. Control then continues to block 537 where the common debugger logic 156 processes the request, as further described below with reference to FIG. 6.

Control then continues to block 540 where the agent 152 sends a request to the common debugger logic 156 to resume the method. Control then continues to block 545 where the common debugger logic 156 processes the request, as further described below with reference to FIG. 6. Control then continues to block 599 where the logic of FIG. 5 returns.

The requests sent by the agent 152 to the common debugger logic 156 in FIG. 5 are exemplary only, and in other embodiments may include a request to set/clear breakpoint in the class; a request to display or alter field(s) in an instance of a class, a request to add watches on fields and/or local variables in the class; a request to view/change fields and/or local variables of a method of the class while the method is currently invoked and on the stack, a request to step into an invocation of a method in the class; a request to pop a frame of the class (popping the topmost stack frame of the thread associated with the requested class), a request to redefine the class, or any other appropriate request.

FIG. 6 depicts a flowchart of example processing for handling requests from the agent 152, according to an embodiment of the invention. Control begins at block 600. Control then continues to block 605 where the common debugger logic 156 receives a request from the agent 152, such as the requests previously described above with reference to FIG. 5.

Control then continues to block 610 where the common debugger logic 156 determines whether the class 160 associated with the request is within the debug domain of the class loader 174 or any subloader that loaded the class 160. The common debugger logic 156 at block 610 determines if the requested class 160 is within a debug domain by asking the class loader 174 that loaded the requested class 160 whether or not the requested class 160 is in the debug domain. The class loader 174 knows the answer to this question by inspecting itself. If the class loader 174 that loaded the requested class 160 has debug enabled, then the requested class 160 is within a debug domain (the “yes” leg of block 610). Otherwise, the requested class 160 is not (the “no” leg of block 610).

If the determination at block 610 is false, then the class 160 associated with the request is not within the domain of the class loader 174 or any subloader, so control continues to block 620 where the common debugger logic 156 rejects the request. The requested class 160 is not within the domain if the request is directed to a class 160 that is outside of the class loader 174 or any subloader. A class 160 is outside of the class loader 174 or any subloader if the class 160 was not loaded by the class loader 174 or subloader. A request is directed to a class 160 if the request is setting/clearing a breakpoint in a method in the class 160; the request is a display or alter of field(s) in an instance of the class 160; the request is adding watches on fields and/or local variables in an instance of the class 160; the request is viewing/changing fields and/or local variables of a method of the class 160 while the method is currently invoked and on the stack; the request steps into an invocation of a method in the class 160; the request is for a popframe of a method in the class 160 (the request pops the topmost stack frame of the thread associated with the requested class 160); or the request redefines the class 160. A pop frame request rolls back the call stack, placing the point where execution would be resumed (after the breakpoint) at the point where some method currently invoked and on the stack was originally called. In effect, this causes re-execution of the method. For a pop frame request to be allowed, either the method making the call or the method being called must be from a class 160 within the debug domain. Control then continues to block 699 where the logic of FIG. 6 returns.

If the determination at block 610 is true, then the class 160 associated with the request is within the debug domain of the class loader 174 or any subloader, so control continues to block 615 where the common debugger logic 156 performs the request. For example, for a pop frame request to be allowed, either the method making the call or the method being called must be from a class 160 within the debug domain. Control then continues to block 699 where the logic of FIG. 6 returns.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of embodiments of the invention. But, the invention may be practiced without these specific details. In other instances, well-known circuits, structures, and techniques have not been shown in detail in order not to obscure the invention.

What is claimed is:

1. A method comprising:
determining whether a class associated with a debug request is within a debug domain of a class loader; and
performing the debug request if the determining is true.

2. The method of claim 1, further comprising:
rejecting the debug request if the determining is false.

3. The method of claim 1, wherein the determining further comprises:
determining whether the class loader loaded the class.

4. The method of claim 1, wherein the determining further comprises:
determining whether the debug request sets a breakpoint in a method of the class.

5. The method of claim 1, wherein the determining further comprises:
determining whether the debug request pops a frame of a method in the class.

6. A signal-bearing medium encoded with instructions, wherein the instructions when executed comprise:
deciding whether debug is enabled for a class in response to a request to load a class;
creating a class loader with debug enabled if the deciding is true; and
keeping the class and all subsequently-loaded classes in interpreted mode if the deciding is true.

7. The signal-bearing medium of claim 6, further comprising:
determining whether the class loader loaded the class in response to a debug request directed to the class; and
performing the debug request if the determining is true.

8. The signal-bearing medium of claim 7, wherein the debug request alters a field in an instance of the class.

9. The signal-bearing medium of claim 7, wherein the debug request adds a watch on a field in an instance of the class.

10. The signal-bearing medium of claim 7, wherein the debug request steps into an invocation of a method in the class.

11. The signal-bearing medium of claim 7, wherein the debug request clears a breakpoint in a method of the class.

12. The signal-bearing medium of claim 7, wherein the debug request displays a field in an instance of the class.

13. The signal-bearing medium of claim 7, wherein the debug request pops a frame of a method in the class.

14. The signal-bearing medium of claim 7, wherein the debug request redefines the class.

15. The signal-bearing medium of claim 7, wherein the debug request sets a breakpoint in a method of the class.

16. The signal-bearing medium of claim 6, further comprising:
rejecting the debug request if the determining is false.

17. A method for configuring a computer, comprising:
configuring the computer to determine whether a class associated with a debug request is within a debug domain of a class loader; and
configuring the computer to perform the debug request if the determining is true.

18. The method of claim 17, further comprising:
configuring the computer to reject the debug request if the determining is false.

19. The method of claim 17, wherein the configuring the computer to determine further comprises:
configuring the computer to determine whether the class loader loaded the class.

20. The method of claim 17, wherein the configuring the computer to determine further comprises:
configuring the computer to determine whether the debug request sets a breakpoint in a method of the class.
